(19) United States
(12) Patent Application Publication
(10) Pub. No.: US 2016/0054755 A1
(43) Pub. Date: Feb. 25, 2016

(54) USB PASS-THROUGH DEVICE

(71) Applicant: EDWARD BRIAN DEPENBROCK, Coral Springs, FL (US)

(72) Inventor: EDWARD BRIAN DEPENBROCK, Coral Springs, FL (US)

(21) Appl. No.: 14/465,197

(22) Filed: Aug. 21, 2014

(51) Int. Cl. G06F 1/16

(52) U.S. Cl. CPC G06F 1/1632; G06F 1/1669; G06F 1/1696

(57) ABSTRACT

A detachable electronic device includes a first data port configured to releasably couple the detachable electronic device to a first remote electronic device. A second data port is configured to releasably couple the detachable electronic device to a second remote electronic device. An electronic system is coupled to the first data port and the second data port

### TECHNICAL FIELD

This disclosure relates to electronic devices and, more particularly, to electronic devices that are releasably coupled to computing devices.

### BACKGROUND

Computing devices often utilize external peripherals devices, such as keyboards, pointing devices, printers, digital cameras, portable media players, hard disk drives, smartphones, personal digital assistants, video game consoles and network adapters. Often, these devices are coupled to data ports on the computer, such as USB ports.

Unfortunately, the quantity of data port included on a computer is often limited and, therefore, they are often all being utilized. Therefore, in the event that a user want to plug e.g., their thumb (i.e., flash) drive into the computer, they may need to unplug e.g., the keyboard, the mouse, the printer, or an external hard drive.

### SUMMARY OF DISCLOSURE

In one implementation, a detachable electronic device includes a first data port configured to releasably couple the detachable electronic device to a first remote electronic device. A second data port is configured to releasably couple the detachable electronic device to a second remote electronic device. An electronic system is coupled to the first data port and the second data port.

One or more of the following features may be included. The first data port and the second data port may be USB data ports. The first remote electronic device may be a computing device. The second remote electronic device may be chosen from the group consisting of a keyboard, a mouse, and a printer. The keyboard, the mouse, and the printer may be USB devices. The electronic system may include a storage system. The storage system may be a flash-memory based storage system.

The electronic system may include a data port hub. The data port hub may be a USB data port hub. The data port hub may be coupled to a cable configured to be coupled to a third remote electronic device. The third remote electronic device may be chosen from the group consisting of a keyboard, a mouse and a printer. The keyboard, the mouse, and the printer may be USB devices.

In another implementation, a detachable electronic device includes a first USB data port configured to releasably couple the detachable electronic device to a computing device. A second USB data port is configured to releasably couple the detachable electronic device to a second remote electronic device. An electronic system is coupled to the first data port and the second data port.

One or more of the following features may be included. The second remote electronic device may be chosen from the group consisting of a keyboard, a mouse, and a printer. The electronic system may include a storage system. The storage system may be a flash-memory based storage system. The electronic system may include a data port hub. The data port hub may be a USB data port hub. The data port hub may be coupled to a cable configured to be coupled to a third remote electronic device. The third remote electronic device may be chosen from the group consisting of a keyboard, a mouse and a printer.

In another implementation, a detachable electronic device includes a first USB data port configured to releasably couple the detachable electronic device to a computing device. A second USB data port is configured to releasably couple the detachable electronic device to a second remote electronic device. An electronic system is coupled to the first data port and the second data port and includes a storage system.

One or more of the following features may be included. The second remote electronic device may be chosen from the group consisting of a keyboard, a mouse, and a printer.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a detachable electronic device positioned between a computing device and a plurality of external devices according to an implementation of the present disclosure;

FIG. 2 is a diagrammatic view of one embodiment of the detachable electronic device of FIG. 1 according to an implementation of the present disclosure;

FIG. 3 is a more-detailed diagrammatic view of the detachable electronic device of FIG. 2 according to an implementation of the present disclosure;

FIG. 4 is a diagrammatic view of another embodiment of the detachable electronic device of FIG. 1 according to an implementation of the present disclosure; and

FIG. 5 is a more-detailed diagrammatic view of the detachable electronic device of FIG. 4 according to an implementation of the present disclosure.

Like reference symbols in the various drawings indicate like elements.

### DETAILED DESCRIPTION OF THE PREFERRED EMBODIMENTS

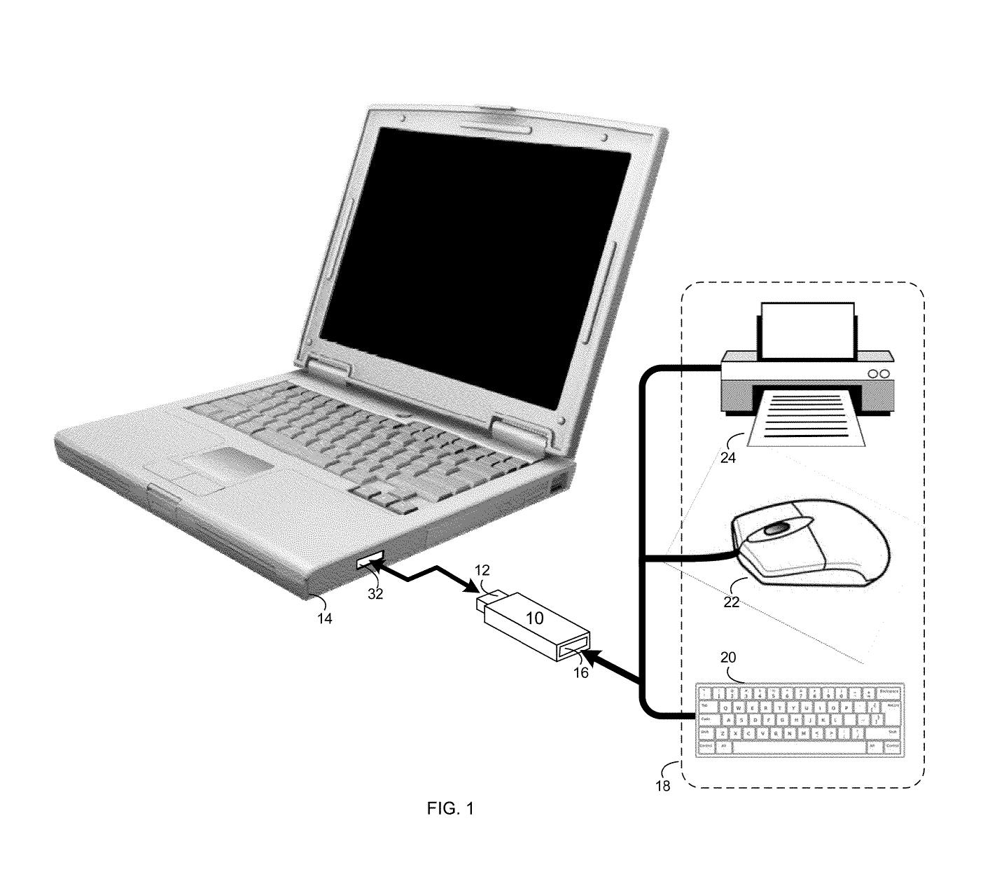

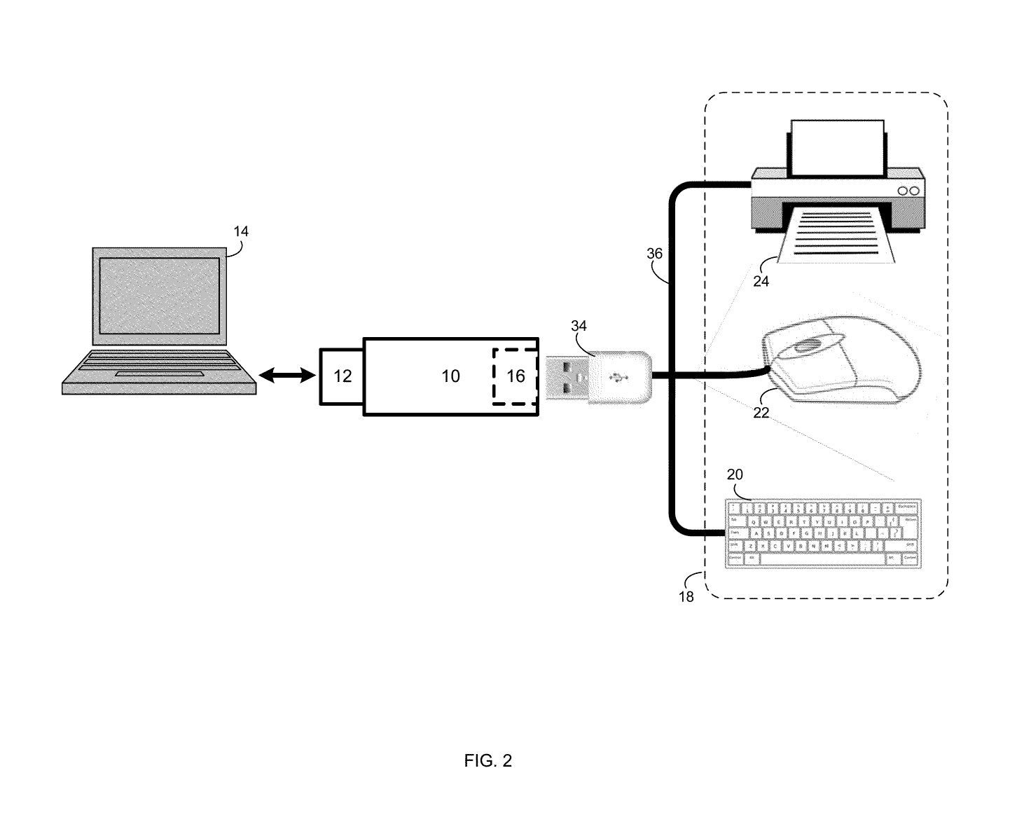

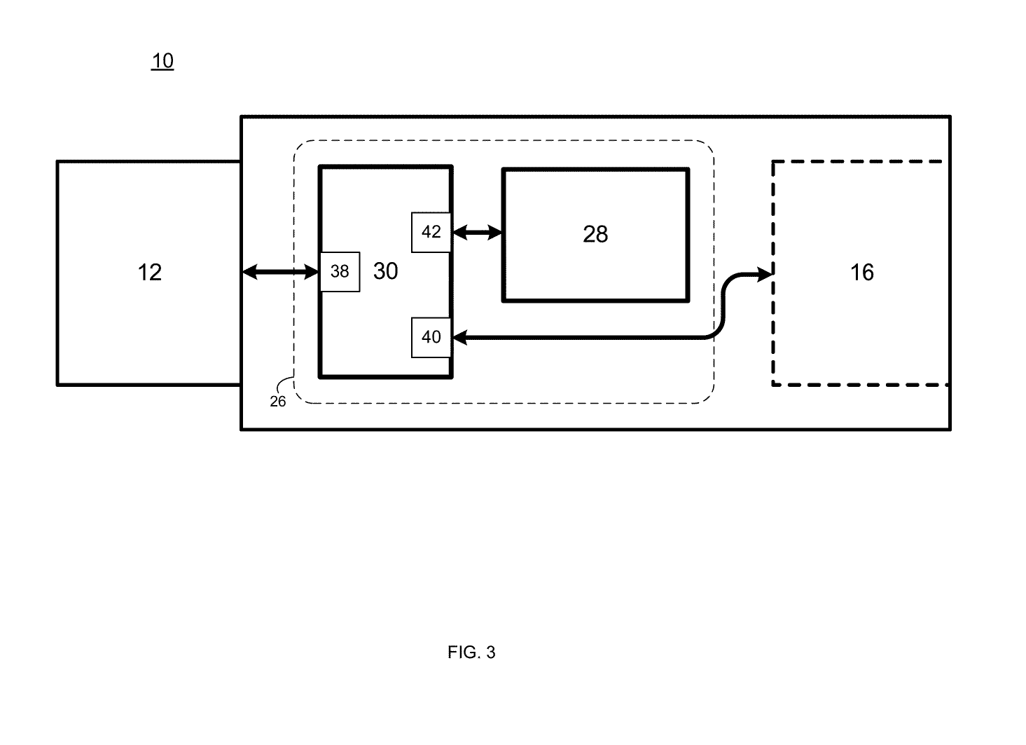

Referring to FIGS. 1-3, there is shown detachable electronic device 10. Detachable electronic device 10 may be configured to releasably engage various electronic devices (or have various electronic devices releasably engage detachable electronic device 10).

Detachable electronic device 10 may include first data port 12 that may be configured to releasably couple detachable electronic device 10 to first remote electronic device 14. An example of first remote electronic device 14 may include, but is not limited to, a computing device (e.g., a laptop computer, a notebook computer, a desktop computer, a server computer, a tablet computer).

Detachable electronic device 10 may also include second data port 16 that may be configured to releasably couple detachable electronic device 10 to second remote electronic device 18. Examples of second remote electronic device 18 may include, but is not limited to, keyboard 20 for use with first remote electronic device 14, mouse 22 for use with first remote electronic device 14, and printer 24 for use with first remote electronic device 14.

An example of first data port 12 and second data port 16 may include, but is not limited to, USB (i.e., Universal Serial Bus) data ports. As is known in the art, Universal Serial Bus is an industry standard that defines the cables, connectors and communications protocols used in a data bus for connection, communication, and power supply between computers and electronic devices. USB was designed to standardize the connection of computer peripherals (including keyboards (e.g., keyboard 20), pointing devices (e.g., mouse 22), printers (e.g., printer 24), digital cameras (not shown), portable media players (not shown), disk drives (not shown), smartphones (not shown), personal digital assistants (not shown), video game consoles (not shown) and network adapters (not shown) to personal computers (e.g., first remote electronic device 14), for both communication and power supply purposes. With the advent of USB, the USB interface has effectively replaced a variety of earlier interfaces, such as serial ports and parallel ports (as well as power supplies for charging portable electronic devices). Accordingly, one or more of keyboard 20, mouse 22, and printer 24 may be configured as a USB device.

Detachable electronic device 10 may include electronic system 26 coupled to first data port 12 and second data port 16, wherein electronic system 26 may include storage system 28. An example of storage system 28 may include, but is not limited to, a flash-memory based storage system. Electronic system 26 may also include data port hub 30. An example of data port hub 30 may include, but is not limited to, a USB data port hub.

As is known in the art, a USB data port hub is a device that expands a single USB data port into several USB data ports so that additional USB data ports are available to connect additional USB devices to a host system (e.g., detachable electronic device 10). USB data port hubs may be built into other devices/equipment (e.g., computers, keyboards, monitors, printers).

Accordingly, data port hub 30 may be configured to include three hub ports (e.g., hub ports 38, 40, 42), wherein first hub port 38 may be configured to couple first data port 12 to data port hub 30; second hub port 40 may be configured to couple second data port 16 to data port hub 30; and third hub port 42 may be configured to couple storage system 28 to data port hub 30.

Accordingly, detachable electronic device 10 may be configured as a USB flash drive that includes first data port 12 for coupling detachable electronic device 10 to e.g., first remote electronic device 14 (e.g., a laptop computer, a notebook computer, a desktop computer, a server computer, a tablet computer). As is known in the art, a USB flash drive is a data storage device that includes flash memory with an integrated Universal Serial Bus (USB) interface (e.g., first data port 12). USB flash drives are typically removable and rewritable; and physically much smaller than optical drives and/or mechanical drives.

Further, in the event that data port 32 (e.g., a USB data port) included within first remote electronic device 14 (e.g., a laptop computer, a notebook computer, a desktop computer, a server computer, a tablet computer) is being utilized by a plug (e.g., USB plug 34) included on USB cable 36 used to attach keyboard 20, mouse 22, or printer 24 to first remote electronic device 14, the user of detachable electronic device 10 may: uncouple USB plug 34 from data port 32 included within first remote electronic device 14; couple first data port 12 of detachable electronic device 10 with port 32 included within first remote electronic device 14; and couple the plug (e.g., USB plug 34) included on USB cable 36 to second data port 16 included within detachable electronic device 10; thus coupling e.g., keyboard 20, mouse 22, or printer 24 to first remote electronic device 14 (through detachable electronic device 10).

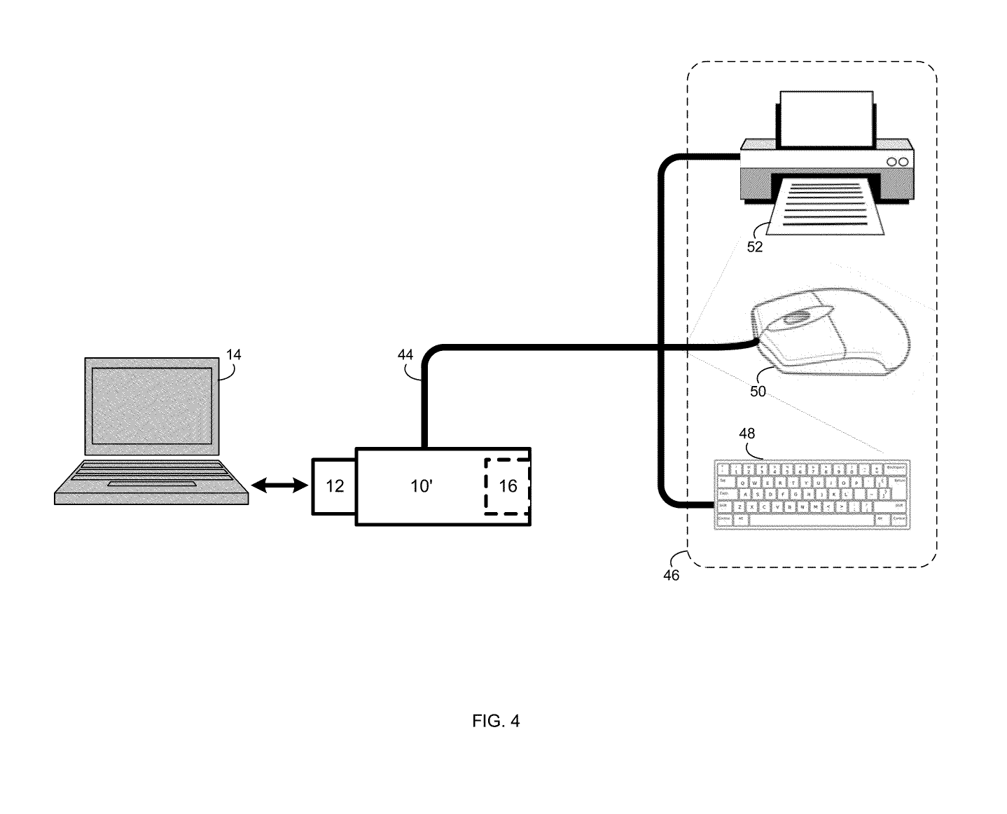

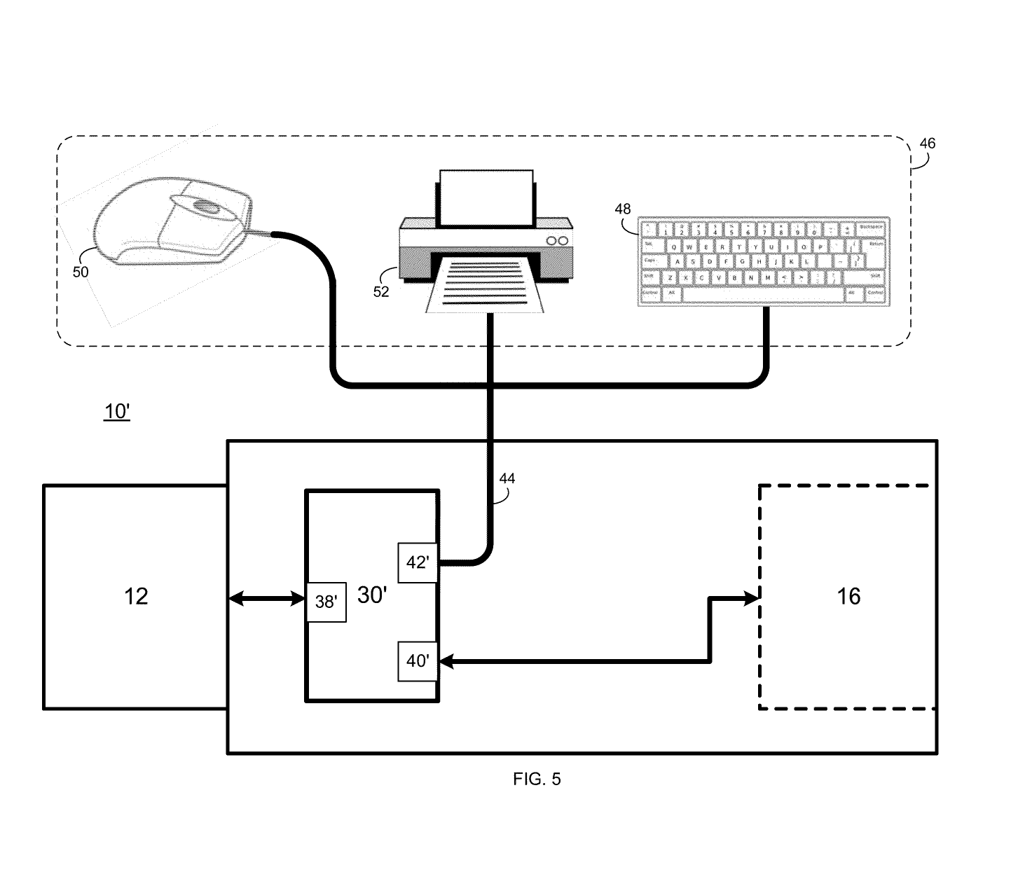

Referring to FIGS. 4-5, there is shown an alternative embodiment of detachable electronic device 10 (namely detachable electronic device 10′). In such an embodiment, detachable electronic device 10′ may include data port hub 30′. Data port hub 30′ may be configured to include three hub ports (e.g., hub ports 38′, 40′, 42′), wherein first hub port 38′ may be configured to couple first data port 12 to data port hub 30′; second hub port 40′ may be configured to couple second data port 16 to data port hub 30′; and third hub port 42′ may be configured to couple cable 44 (e.g., a USB cable) to data port hub 30′.

Cable 44 may be configured to releasable couple detachable electronic device 10′ to third remote electronic device 46. Examples of third remote electronic device 46 may include, but is not limited to, keyboard 48, mouse 50 and printer 52. As with data port hub 30, an example of data port hub 30′ may include, but is not limited to, a USB data port hub. Therefore, one or more of keyboard 48, mouse 50 and printer 52 may be configured as a USB device.

Accordingly and in such an embodiment, detachable electronic device 10′ may be positioned at the end of: a keyboard cable (e.g., the keyboard cable used with keyboard 48), a mouse cable (e.g., the mouse cable used with mouse 50), or a printer cable (e.g., the printer cable used with printer 52).

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A detachable electronic device comprising:
a first data port configured to releasably couple the detachable electronic device to a first remote electronic device;
a second data port configured to releasably couple the detachable electronic device to a second remote electronic device; and
an electronic system coupled to the first data port and the second data port.

2. The detachable electronic device of claim 1 wherein the first data port and the second data port are USB data ports.

3. The detachable electronic device of claim 1 wherein the first remote electronic device is a computing device.

4. The detachable electronic device of claim 1 wherein the second remote electronic device is chosen from the group consisting of a keyboard, a mouse, and a printer.

5. The detachable electronic device of claim 4 wherein the keyboard, the mouse, and the printer are USB devices.

6. The detachable electronic device of claim 1 wherein the electronic system includes a storage system.

7. The detachable electronic device of claim 6 wherein the storage system is a flash-memory based storage system.

8. The detachable electronic device of claim 1 wherein the electronic system includes a data port hub.

9. The detachable electronic device of claim 8 wherein the data port hub is a USB data port hub.

10. The detachable electronic device of claim 8 wherein the data port hub is coupled to a cable configured to be coupled to a third remote electronic device.

11. The detachable electronic device of claim 10 wherein the third remote electronic device is chosen from the group consisting of a keyboard, a mouse and a printer.

12. The detachable electronic device of claim 11 wherein the keyboard, the mouse, and the printer are USB devices.

13. A detachable electronic device comprising:
a first USB data port configured to releasably couple the detachable electronic device to a computing device;
a second USB data port configured to releasably couple the detachable electronic device to a second remote electronic device; and
an electronic system coupled to the first data port and the second data port.

14. The detachable electronic device of claim 13 wherein the second remote electronic device is chosen from the group consisting of a keyboard, a mouse, and a printer.

15. The detachable electronic device of claim 13 wherein the electronic system includes a storage system.

16. The detachable electronic device of claim 15 wherein the storage system is a flash-memory based storage system.

17. The detachable electronic device of claim 13 wherein the electronic system includes a data port hub.

18. The detachable electronic device of claim 17 wherein the data port hub is a USB data port hub.

19. The detachable electronic device of claim 17 wherein the data port hub is coupled to a cable configured to be coupled to a third remote electronic device.

20. The detachable electronic device of claim 19 wherein the third remote electronic device is chosen from the group consisting of a keyboard, a mouse and a printer.

21. A detachable electronic device comprising:
a first USB data port configured to releasably couple the detachable electronic device to a computing device;
a second USB data port configured to releasably couple the detachable electronic device to a second remote electronic device; and
an electronic system coupled to the first data port and the second data port and including a storage system.

22. The detachable electronic device of claim 13 wherein the second remote electronic device is chosen from the group consisting of a keyboard, a mouse, and a printer.
